(19) United States
(12) Patent Application Publication
(10) Pub. No.: US 2022/0320564 A1
(43) Pub. Date: Oct. 6, 2022

(54) FUEL CELL SYSTEM

(71) Applicant: HONDA MOTOR CO., LTD., Tokyo (JP)

(72) Inventors: Naoki Tanaka, Wako-shi (JP); Seiji Sugiura, Wako-shi (JP)

(21) Appl. No.: 17/671,645

(22) Filed: Feb. 15, 2022

(30) Foreign Application Priority Data
Mar. 30, 2021 (JP) 2021-057425

(51) Int. Cl. H01M 8/2484; H01M 8/241; H01M 8/04082; H01M 8/04089

(52) U.S. Cl. CPC H01M 8/2484; H01M 8/241; H01M 8/04201; H01M 8/04089; H01M 2008/1095

(57) ABSTRACT

A fuel cell system includes a plurality of fuel cell stacks, and a supply pipeline and a discharge pipeline that are connected to a supply channel and a discharge channel of each of the fuel cell stacks. A fluid sequentially supplied to the plurality of fuel cells in a stacking direction flows through the supply channel. A fluid sequentially discharged from the plurality of fuel cells in the stacking direction flows through the discharge channel A flowing direction of the fluid in the supply channel is a direction from a first end plate toward a second end plate. A flowing direction of the fluid in the discharge channel is a direction from the first end plate toward the second end plate.

### CROSS-REFERENCE TO RELATED APPLICATION

Priority is claimed on Japanese Patent Application No. 2021-057425, filed Mar. 30, 2021, the content of which is incorporated herein by reference.

### BACKGROUND OF THE INVENTION

### Field of the Invention

The present invention relates to a fuel cell system.

### Description of Related Art

In the related art, for example, a fuel cell system including two stacks having a plurality of stacked cells and disposed next to each other in a direction perpendicular to a stacking direction of the plurality of cells, and supply pipelines and discharge pipelines connected to a supply manifold and a discharge manifold for a gas at an end plate on one side in the stacking direction of each of the stacks is known (for example, see Japanese Unexamined Patent Application, First Publication No. 2006-302707).

### SUMMARY OF THE INVENTION

Incidentally, in the above-mentioned fuel cell system, a flow direction of a gas in the supply manifold and a flow direction of a gas in the discharge manifold in each of the two stacks are opposite to the stacking direction, a pressure difference of the gas on one side in the stacking direction of the plurality of cells becomes relatively large, and a pressure difference of the gas on the side opposite to the one side in the stacking direction becomes relatively small. Accordingly, a supply amount of the gas on the one side in the stacking direction becomes relatively large, a supply amount of the gas on the side opposite to the one side in the stacking direction becomes relatively small, and a problem occurs in which a gas distribution between the plurality of cells in the stacking direction becomes irregular.

In addition, for example, when a plurality of (three or more) stacks are arranged in a direction perpendicular to the stacking direction of the plurality of cells and the plurality of stacks are sequentially connected to the supply pipeline, supply of the gas in the stack downstream from the flow of the gas becomes relatively lower, and a problem occurs in which supply of the gas between the plurality of stacks becomes irregular.

In addition, for example, when a plurality of (three or more) stacks are arranged in the direction perpendicular to the stacking direction of the plurality of cells and the plurality of stacks are sequentially connected to the discharge pipeline, discharge of the gas in the stack downstream from the flow of the gas becomes relatively lower, discharge of the gas between the plurality of stacks becomes irregular, and a problem occurs in which efficiency of gas exchange decreases.

An aspect of the present invention is directed to providing a fuel cell system capable of improving electric power generation efficiency of a plurality of stacked fuel cells and a plurality of fuel cell stacks.

In order to solve the above-mentioned problems and accomplish purposes related thereto, the present invention employs the following aspects.

(1) A fuel cell system according to an aspect of the present invention includes at least one fuel cell stack having a plurality of cells that are stacked; a supply channel provided in the fuel cell stack and through which a fluid sequentially supplied to the plurality of cells in a stacking direction flows; and a discharge channel provided in the fuel cell stack and through which the fluid sequentially discharged from the plurality of cells in the stacking direction flows, wherein, with respect to a first end and a second end that are both ends of the fuel cell stack in the stacking direction, a flowing direction of the fluid in the supply channel is a direction from the first end toward the second end, and a flowing direction of the fluid in the discharge channel is a direction from the first end toward the second end.

(2) The fuel cell system according to the aspect of the above-mentioned (1) may include a supply pipeline that is provided outside the plurality of fuel cell stacks and that is sequentially connected to the supply channels of the plurality of fuel cell stacks such that the fluid flows therethrough, wherein a cross section of a flow in the supply pipeline varies in a reducing tendency from an upstream side toward a downstream side of the supply pipeline.

(3) The fuel cell system according to the aspect of the above-mentioned (1) or (2) may include a discharge pipeline that is provided outside the plurality of fuel cell stacks and that is sequentially connected to the discharge channels of the plurality of fuel cell stacks such that the fluid flows therethrough, wherein a cross section of a flow in the discharge pipeline varies in an expanding tendency from an upstream side toward a downstream side of the discharge pipeline.

(4) The fuel cell system according to the aspect of the above-mentioned (2) may include a discharge pipeline that is provided outside the plurality of fuel cell stacks and that is sequentially connected to the discharge channels of the plurality of fuel cell stacks in a same connection sequence as a connection sequence in which the supply pipeline is sequentially connected to the supply channels of the plurality of fuel cell stacks flows, such that the fluid flows therethrough, wherein a cross section of the flow in the discharge pipeline varies in an expanding tendency from an upstream side toward a downstream side of the discharge pipeline.

According to the aspect of the above-mentioned (1), for example, in comparison with the case in which the flowing direction in the supply channel and the flowing direction in the discharge channel are opposite directions, pressure differences on the side of the first end and the side of the second end of the plurality of cells can be made evenly close to each other, and it is possible to improve electric power generation efficiency by improving gas exchange efficiency or the like in the plurality of cells.

In the case of the aspect of the above-mentioned (2), for example, in comparison with the case in which a size of a cross section of the flow in the supply pipeline is constant, the pressure differences on the upstream side and the downstream side of the supply pipeline can be made evenly close to each other, and the fluid can be uniformly supplied to the plurality of fuel cell stacks. Accordingly, power generation efficiency in the plurality of fuel cell stacks can be improved.

In the case of the aspect of the above-mentioned (3), for example, in comparison with the case in which a size of the cross section of the flow in the discharge pipeline is constant, the pressure differences on the upstream side and the downstream side of the discharge pipeline can be made evenly close to each other, and the fluid can be uniformly discharged from the plurality of fuel cell stacks. Accordingly, it is possible to improve power generation efficiency in the plurality of fuel cell stacks.

In the case of the aspect of the above-mentioned (4), for example, in comparison with the case in which the size of the cross section of the flow in the discharge pipeline is constant, the pressure difference on the upstream side and the downstream side of the discharge pipeline can be made evenly close to each other, and the fluid can be uniformly discharged from the plurality of fuel cell stacks.

For example, in comparison with the case in which a connection sequence of the plurality of supply channels with respect to the supply pipelines in the plurality of fuel cell stacks is opposite to a connection sequence of the plurality of discharge channels with respect to the discharge pipeline, discharge efficiency of the fluid from the plurality of fuel cell stacks can be improved.

Accordingly, electric power generation efficiency in the plurality of fuel cell stacks can be improved.

### BRIEF DESCRIPTION OF THE DRAWINGS

FIG. 1 is a view schematically showing a configuration of a fuel cell system according to an embodiment of the present invention.

FIG. 2 is a view schematically showing a configuration of a fuel cell system according to a first variant of the embodiment of the present invention.

FIG. 3 is a view schematically showing a configuration of a fuel cell system according to a second variant of the embodiment of the present invention.

FIG. 4 is a view schematically showing a configuration of a fuel cell system of a comparative example of the embodiment of the present invention.

FIG. 5 is a view showing an example of an inlet pressure and an outlet pressure of each of the plurality of fuel cell stacks of the fuel cell system according to the second variant and the comparative example of the embodiment of the present invention.

FIG. 6 is a view showing an example of a variation in flow rates of each of the plurality of fuel cell stacks of the fuel cell system according to the second variant and the comparative example of the embodiment of the present invention.

### DETAILED DESCRIPTION OF THE INVENTION

Hereinafter, a fuel cell system 10 according to an embodiment of the present invention will be described with reference to the accompanying drawings.

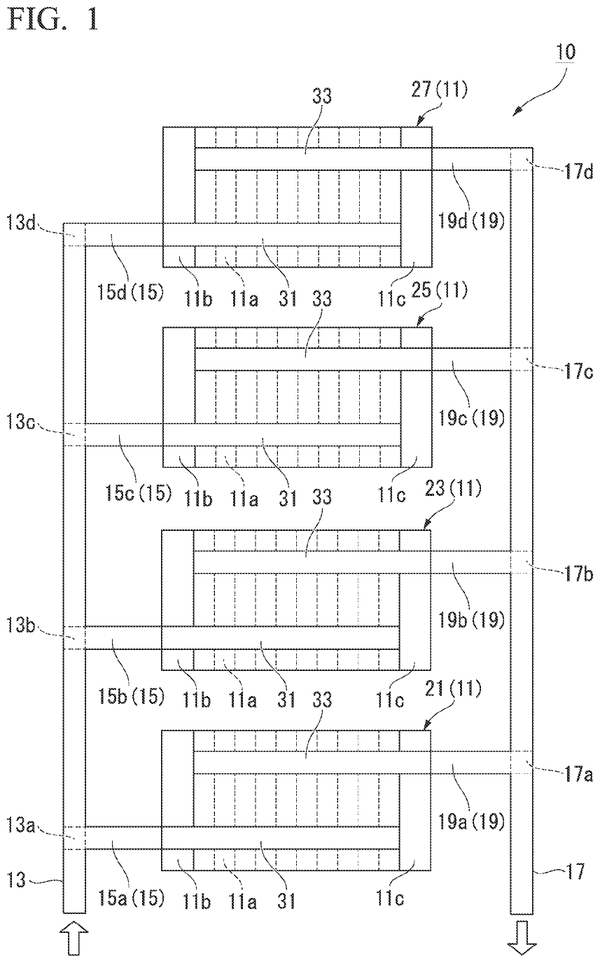

FIG. 1 is a view schematically showing a configuration of the fuel cell system 10 according to the embodiment.

As shown in FIG. 1, the fuel cell system 10 according to the embodiment includes at least one fuel cell stack 11, a supply pipeline 13, at least one inlet pipeline 15, a discharge pipeline 17, and at least one outlet pipeline 19.

The at least one fuel cell stack 11 includes, for example, a first fuel cell stack 21, a second fuel cell stack 23, a third fuel cell stack 25, and a fourth fuel cell stack 27.

Each of the fuel cell stacks 11 is, for example, a solid polymer type fuel cell. Each of the fuel cell stacks 11 includes a plurality of fuel cells 11a that are stacked, and a pair of end plates (a first end plate (a first end) 11b and a second end plate (a second end) 11c) that sandwich the stacked body of the plurality of fuel cells from both sides in the stacking direction.

Each of the fuel cells 11a includes an electrolyte electrode structure, and a pair of separators that sandwich the electrolyte electrode structure. The electrolyte electrode structure includes a solid polymer electrolyte membrane, and a fuel electrode and an oxygen electrode that sandwich the solid polymer electrolyte membrane. The solid polymer electrolyte membrane includes a cation exchange membrane or the like. The fuel electrode (anode) includes an anode catalyst, a gas diffusion layer, and the like. The oxygen electrode (cathode) includes a cathode catalyst, a gas diffusion layer, and the like.

Each of the fuel cell stacks 11 generates electrice power using a catalytic reaction between a fuel gas including hydrogen supplied to the anode and an oxidant gas such as air or the like including oxygen supplied to the cathode.

The plurality of fuel cell stacks 11 including the first fuel cell stack 21, the second fuel cell stack 23, the third fuel cell stack 25 and the fourth fuel cell stack 27 are arranged, for example, sequentially in a direction perpendicular to the stacking direction while having the stacking directions of the plurality of fuel cells 11a parallel to each other.

Each of the fuel cell stacks 11 includes a supply channel 31 through which a predetermined fluid supplied to each of the plurality of fuel cells 11a flows, and a discharge channel 33 through which a predetermined fluid discharged from each of the plurality of fuel cells 11a flows.

The supply channel 31 is connected to the inlet pipeline 15 and the supply pipeline 13, which will be described below. For example, the supply channel 31 is connected to the inlet pipeline 15 on the first end plate 11b of the fuel cell stack 11.

The discharge channel 33 is connected to the outlet pipeline 19 and the discharge pipeline 17, which will be described below. For example, the discharge channel 33 is connected to the outlet pipeline 19 on the second end plate 11c of the fuel cell stack 11.

Each of the supply channel 31 and the discharge channel 33 is disposed in the stacking direction of the plurality of fuel cells 11a. A flowing direction of a predetermined fluid in the supply channel 31 and a flowing direction of a predetermined fluid in the discharge channel 33 are the same as the stacking direction. For example, the flowing direction of the predetermined fluid in each of the supply channel 31 and the discharge channel 33 is a direction from the side of the first end plate 11b toward the second end plate 11c.

The supply channel 31 includes a fuel supply channel through which a fuel gas flows, an oxidant supply channel through which an oxidant gas flows, and a coolant supply channel through which a cooling medium supplied to cool the plurality of fuel cells 11a flows.

The discharge channel 33 includes a fuel discharge channel through which a fuel gas flows, an oxidant discharge channel through which an oxidant gas flows, and a coolant discharge channel through which a cooling medium discharged after cooling the plurality of fuel cells 11a flows.

The supply pipeline 13 is connected to the supply channels 31 of the plurality of fuel cell stacks 11 via the plurality of inlet pipelines 15 in sequence. A predetermined fluid supplied to the plurality of fuel cell stacks 11 flows through the supply pipeline 13 and the plurality of inlet pipelines 15. The number of the plurality of inlet pipelines 15 is the same as the number of the plurality of fuel cell stacks 11.

The supply pipeline 13 includes a plurality of branching portions sequentially connected to the plurality of inlet pipelines 15. The plurality of branching portions are, for example, a first branching portion 13a, a second branching portion 13b, a third branching portion 13c and a fourth branching portion 13d, which are sequentially provided at predetermined intervals from an upstream side toward a downstream side of the supply pipeline 13.

The plurality of inlet pipelines 15 include, for example, a first inlet pipeline 15a, a second inlet pipeline 15b, a third inlet pipeline 15c and a fourth inlet pipeline 15d, which have the same shape as each other.

The first inlet pipeline 15a is connected to the first branching portion 13a and the supply channel 31 of the first fuel cell stack 21. The second inlet pipeline 15b is connected to the second branching portion 13b and the supply channel 31 of the second fuel cell stack 23. The third inlet pipeline 15c is connected to the third branching portion 13c and the supply channel 31 of the third fuel cell stack 25. The fourth inlet pipeline 15d is connected to the fourth branching portion 13d and the supply channel 31 of the fourth fuel cell stack 27.

The supply pipeline 13 and the inlet pipeline 15 include a fuel supply pipeline and a fuel inlet pipeline through which a fuel gas flows, an oxidant inlet pipeline and an oxidant branching pipeline through which an oxidant gas flows, and a coolant supply pipeline and a coolant inlet pipeline through which a cooling medium flows.

The discharge pipeline 17 is connected to the discharge channels 33 of the plurality of fuel cell stacks 11 in sequence. A predetermined fluid supplied to the plurality of fuel cell stacks 11 flows through the discharge pipeline 17 and the plurality of outlet pipelines 19. The number of the plurality of outlet pipelines 19 is the same as the number of the plurality of fuel cell stacks 11.

The discharge pipeline 17 includes a plurality of merging portions sequentially connected to the plurality of outlet pipelines 19. The plurality of merging portions are, for example, a first merging portion 17a, a second merging portion 17b, a third merging portion 17c and a fourth merging portion 17d sequentially provided at predetermined intervals from a downstream side toward an upstream side of the discharge pipeline 17.

The plurality of outlet pipelines 19 include, for example, a first outlet pipeline 19a, a second outlet pipeline 19b, a third outlet pipeline 19c and a fourth outlet pipeline 19d, which have the same shape as each other.

The first outlet pipeline 19a is connected to the first merging portion 17a and the discharge channel 33 of the first fuel cell stack 21. The second outlet pipeline 19b is connected to the second merging portion 17b and the discharge channel 33 of the second fuel cell stack 23. The third outlet pipeline 19c is connected to the third merging portion 17c and the discharge channel 33 of the third fuel cell stack 25. The fourth outlet pipeline 19d is connected to the fourth merging portion 17d and the discharge channel 33 of the fourth fuel cell stack 27.

The discharge pipeline 17 and the outlet pipeline 19 include a fuel discharge pipeline and a fuel outlet pipeline through which a fuel gas flows, an oxidant discharge pipeline and an oxidant outlet pipeline through which an oxidant gas flows, and a coolant discharge pipeline and a coolant outlet pipeline through which a cooling medium flows.

In the embodiment, a flowing direction of a predetermined fluid in the supply pipeline 13 and a flowing direction of a predetermined fluid in the discharge pipeline 17 are, for example, directions opposite to a direction perpendicular to the stacking direction of the plurality of fuel cells 11a.

In the embodiment, sizes of the cross sections of the flows of the predetermined fluid in the supply pipeline 13, the plurality of inlet pipelines 15, the discharge pipeline 17 and the plurality of outlet pipelines 19 are the same. The sizes of the cross sections of the flows of the predetermined fluid in the supply pipeline 13 and the discharge pipeline 17 are constant in a lengthwise direction. The size of the cross section is, for example, a diameter of a circular pipe, a water power equivalent diameter of a pipeline having another cross-sectional shape other than the circular pipe (an equivalent diameter: a diameter of an equivalent circular pipe), or the like.

As described above, in the fuel cell system 10 of the embodiment, since the flowing directions of the predetermined fluid in the supply channel 31 and the discharge channel 33 are the same direction, electric power generation efficiency can be improved. For example, in comparison with the case in which the flowing direction in the supply channel 31 and the flowing direction in the discharge channel 33 are opposite directions, the pressure differences can be made evenly close to each other on the side of the first end plate 11b and the side of the second end plate 11c in the stacking direction of the plurality of fuel cells 11a. Accordingly, it is possible to improve the electric power generation efficiency by improving the gas exchange efficiency or the like in the plurality of fuel cells 11a.

### (Variant)

Hereinafter, a variant of the embodiment will be described. Further, the same components as the above-mentioned embodiment are designated by the same reference signs and description thereof will be omitted or simplified.

In the above-mentioned embodiment, while the size of the cross section of the flow of the predetermined fluid in the supply pipeline 13 is constant in the lengthwise direction, there is no limitation thereto.

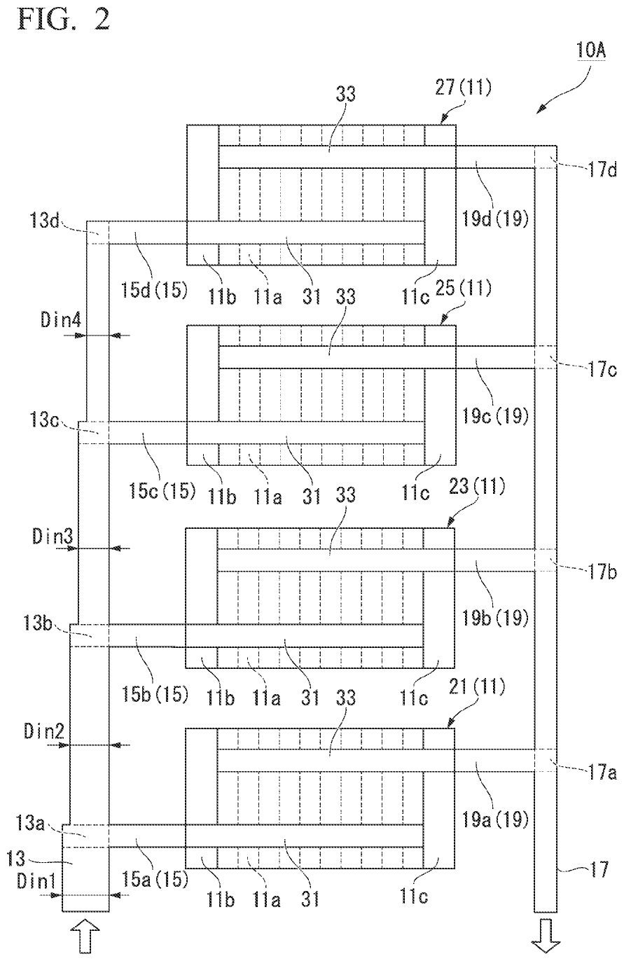

FIG. 2 is a view schematically showing a configuration of a fuel cell system 10A according to a first variant of the embodiment.

As shown in FIG. 2, in the fuel cell system 10A of the first variant, the size of the cross section of the flow of the predetermined fluid in the supply pipeline 13 varies in a reducing tendency from the upstream side toward the downstream side of the supply pipeline 13.

For example, a water power equivalent diameter Din1 to the first branching portion 13a upstream from the supply pipeline 13 is relatively larger than a water power equivalent diameter Din2 from the first branching portion 13a to the second branching portion 13b. A water power equivalent diameter Din3 from the second branching portion 13b to the third branching portion 13c is relatively larger than a water power equivalent diameter Din4 from the third branching portion 13c to the fourth branching portion 13d. The water power equivalent diameter Din4 from the third branching portion 13c to the fourth branching portion 13d is the same as the water power equivalent diameter of each of the inlet pipelines 15a, 15b, 15c and 15d.

According to the first variant, since the size of the cross section of the flow of the predetermined fluid in the supply pipeline 13 varies in a reducing tendency from the upstream side toward the downstream side of the supply pipeline 13, electric power generation efficiency of the plurality of fuel cell stacks 11 can be improved. For example, in comparison with the case in which the size of the cross section of the flow in the supply pipeline 13 is constant, the pressure differences upstream and downstream from the supply pipeline 13 can be made evenly close to each other, and the predetermined fluid can be uniformly supplied to the plurality of fuel cell stacks 11.

According to the above-mentioned embodiment and first variant, while the size of the cross section of the flow of the predetermined fluid in the discharge pipeline 17 is constant in the lengthwise direction, there is no limitation thereto.

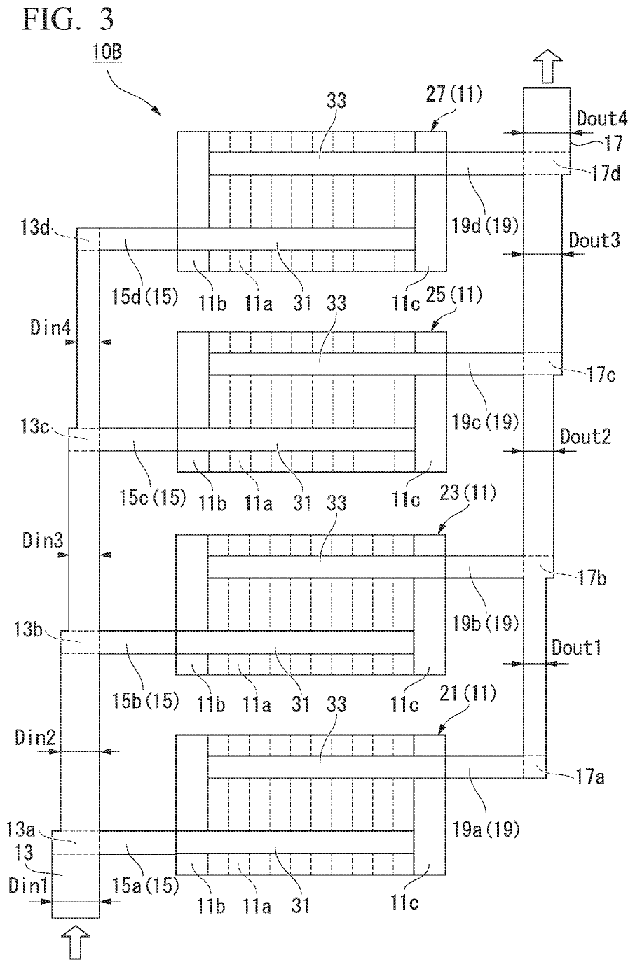

FIG. 3 is a view schematically showing a configuration of a fuel cell system 10B according to a second variant of the embodiment.

As shown in FIG. 3, in the fuel cell system 10B of the second variant, the size of the cross section of the flow of the predetermined fluid in the discharge pipeline 17 varies in an expanding tendency from the upstream side toward the downstream side of the discharge pipeline 17.

A plurality of merging portions in the discharge pipeline 17 of the second variant are, for example, a first merging portion 17a, a second merging portion 17b, a third merging portion 17c and a fourth merging portion 17d, which are sequentially provided at predetermined intervals from the upstream side toward the downstream side of the discharge pipeline 17. A connection sequence of the plurality of supply channels 31 with respect to the supply pipeline 13 in the plurality of fuel cell stacks 11 is the same as a connection sequence of the plurality of discharge channels 33 with respect to the discharge pipeline 17.

In the second variant, for example, the flowing direction of the predetermined fluid in the supply pipeline 13 and the flowing direction of the predetermined fluid in the discharge pipeline 17 are the same direction as a direction perpendicular to the stacking direction of the plurality of fuel cells 11a.

In the second variant, for example, water power equivalent diameter Dout1 from the first merging portion 17a to the second merging portion 17b upstream from the discharge pipeline 17 is relatively smaller than a water power equivalent diameter Dout2 from the second merging portion 17b to the third merging portion 17c, and is the same as the water power equivalent diameter of each of the outlet pipelines 19a, 19b, 19c and 19d. The water power equivalent diameter Dout2 from the second merging portion 17b to the third merging portion 17c is relatively smaller than a water power equivalent diameter Dout3 from the third merging portion 17c to the fourth merging portion 17d. The water power equivalent diameter Dout3 from the third merging portion 17c to the fourth merging portion 17d is smaller than a water power equivalent diameter Dout4 from the fourth merging portion 17d toward a downstream side of the discharge pipeline 17.

In the fuel cell system 10B of the second variant, like the fuel cell system 10A of the above-mentioned first variant, for example, the water power equivalent diameter Din1 to the first branching portion 13a upstream from the supply pipeline 13 is relatively greater than the water power equivalent diameter Din2 from the first branching portion 13a to the second branching portion 13b. The water power equivalent diameter Din3 from the second branching portion 13b to the third branching portion 13c is relatively greater than the water power equivalent diameter Din4 from the third branching portion 13c to the fourth branching portion 13d. The water power equivalent diameter Din4 from the third branching portion 13c to the fourth branching portion 13d is the same as the water power equivalent diameter of each of the inlet pipelines 15a, 15b, 15c and 15d.

Hereinafter, comparison of the embodiment (for example, the fuel cell system 10B of the second variant) with a fuel cell system 30 of a comparative example will be described.

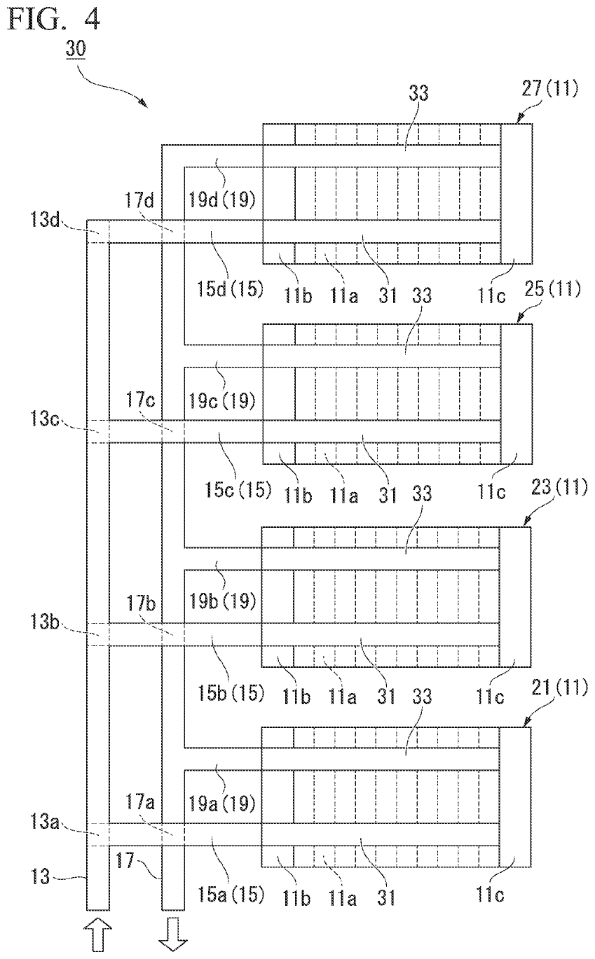

FIG. 4 is a view schematically showing a configuration of the fuel cell system 30 according to the comparative example of the embodiment. The fuel cell system 30 of the comparative example is distinguished from the fuel cell system 10 of the above-mentioned embodiment in that the discharge channel 33 is connected to the outlet pipeline 19 on the first end plate 11b of the fuel cell stack 11. Accordingly, in the comparative example, a flowing direction of a predetermined fluid in the supply channel 31 and a flowing direction of a predetermined fluid in the discharge channel 33 are opposite directions in the stacking direction. For example, while the flowing direction of the predetermined fluid in the supply channel 31 is a direction from the first end plate 11b toward the second end plate 11c, on the other hand, the flowing direction of the predetermined fluid in the discharge channel 33 is a direction from the second end plate 11c toward the first end plate 11b.

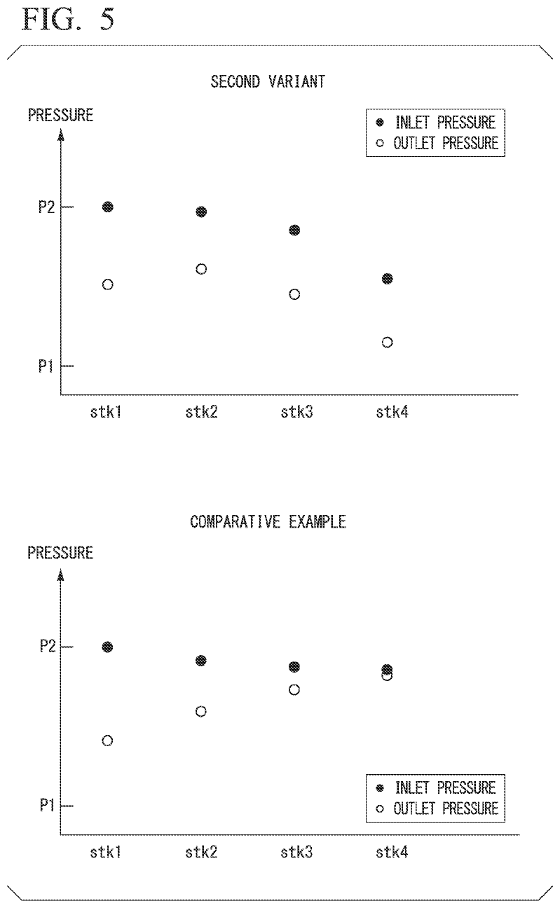

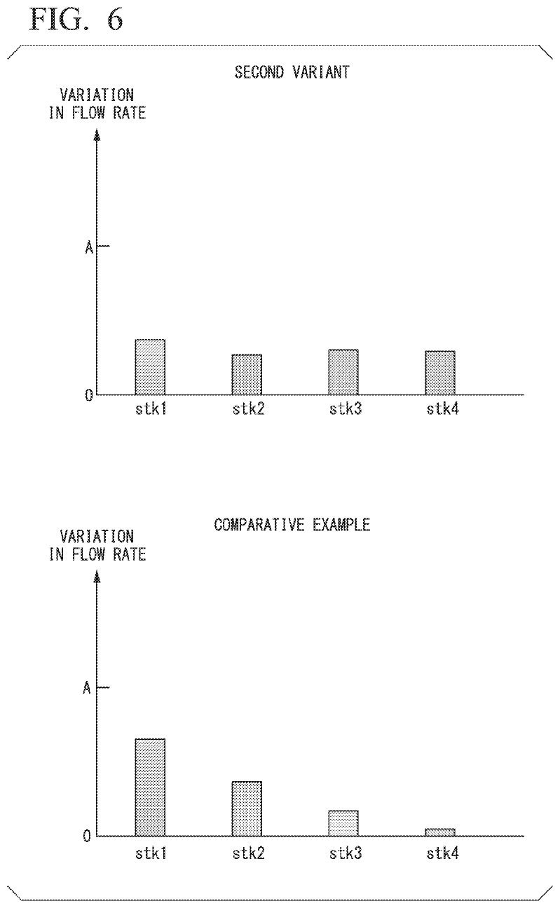

FIG. 5 is a view showing an example of an inlet pressure and an outlet pressure of each of the plurality of fuel cell stacks 11 of the fuel cell systems 10B and 30 according to the second variant of the embodiment and the comparative example. FIG. 6 is a view showing an example of a variation in flow rate of each of the plurality of fuel cell stacks 11 of the fuel cell systems 10B and 30 according to the second variant of the embodiment and the comparative example.

As shown in FIG. 5 and FIG. 6, in the comparative example, in comparison with the second variant, a difference between the inlet pressure and the outlet pressure and a variation in flow rate are greatly different among the first fuel cell stack 21 (stk1), the second fuel cell stack 23 (stk2), the third fuel cell stack 25 (stk3) and the fourth fuel cell stack 27 (stk4). On the other hand, in the second variant, a difference between the inlet pressure and the outlet pressure and a variation in flow rate are almost the same among the plurality of fuel cell stacks 11.

According to the second variant, since the size of the cross section of the flow of the predetermined fluid in the discharge pipeline 17 varies in an expanding tendency from the upstream side toward the downstream side of the discharge pipeline 17, electric power generation efficiency of the plurality of fuel cell stacks 11 can be improved. For example, in comparison with the case in which the size of the cross section of the flow in the discharge pipeline 17 is constant, the pressure differences on the upstream side and the downstream side of the discharge pipeline 17 can be made evenly close to each other, and the fluid can be uniformly discharged from the plurality of fuel cell stacks 11.

In addition, since a connection sequence of the plurality of supply channels 31 with respect to the supply pipeline 13 in the plurality of fuel cell stacks 11 is the same as a connection sequence of the plurality of discharge channels 33 with respect to the discharge pipeline 17, the flowing direction of the predetermined fluid in the supply pipeline 13 is the same as the flowing direction of the predetermined fluid in the discharge pipeline 17, and electric power generation efficiency in the plurality of fuel cell stacks 11 can be improved. For example, in comparison with the case in which a connection sequence of the plurality of supply channels 31 with respect to the supply pipeline 13 in the plurality of fuel cell stacks 11 is opposite to a connection sequence of the plurality of discharge channels 33 with respect to the discharge pipeline 17, discharge efficiency of the predetermined fluid from the plurality of fuel cell stacks 11 can be improved.

In the above-mentioned first variant and second variant, as shown in FIG. 2 and FIG. 3, the size of the cross section of each of the supply pipeline 13 and the discharge pipeline 17 is varied in a stepped shape, there is no limitation thereto.

For example, since a shape of an inner surface of each of the pipelines 13 and 17 is an appropriate curved surface shape or the like, a size of a cross section of each of the supply pipeline 13 and the discharge pipeline 17 may be smoothly varied.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A fuel cell system comprising:
at least one fuel cell stack having a plurality of cells that are stacked;
a supply channel provided in the fuel cell stack and through which a fluid sequentially supplied to the plurality of cells in a stacking direction flows; and
a discharge channel provided in the fuel cell stack and through which the fluid sequentially discharged from the plurality of cells in the stacking direction flows,
wherein, with respect to a first end and a second end that are both ends of the fuel cell stack in the stacking direction,
a flowing direction of the fluid in the supply channel is a direction from the first end toward the second end, and
a flowing direction of the fluid in the discharge channel is a direction from the first end toward the second end.

2. The fuel cell system according to claim 1, comprising a supply pipeline that is provided outside the plurality of fuel cell stacks and that is sequentially connected to the supply channels of the plurality of fuel cell stacks such that the fluid flows therethrough,
wherein a cross section of a flow in the supply pipeline varies in a reducing tendency from an upstream side toward a downstream side of the supply pipeline.

3. The fuel cell system according to claim 1, comprising a discharge pipeline that is provided outside the plurality of fuel cell stacks and that is sequentially connected to the discharge channels of the plurality of fuel cell stacks such that the fluid flows therethrough,
wherein a cross section of a flow in the discharge pipeline varies in an expanding tendency from an upstream side toward a downstream side of the discharge pipeline.

4. The fuel cell system according to claim 2, comprising a discharge pipeline that is provided outside the plurality of fuel cell stacks and that is sequentially connected to the discharge channels of the plurality of fuel cell stacks in a same connection sequence as a connection sequence in which the supply pipeline is sequentially connected to the supply channels of the plurality of fuel cell stacks flows, such that the fluid flows therethrough,
wherein a cross section of the flow in the discharge pipeline varies in an expanding tendency from an upstream side toward a downstream side of the discharge pipeline.
